(19) United States
(12) Patent Application Publication
(10) Pub. No.: US 2017/0188147 A1
(43) Pub. Date: Jun. 29, 2017

(54) ACOUSTIC FEEDBACK CANCELLATION BASED ON CESPTRAL ANALYSIS

(71) Applicant: UNIVERSIDADE DO PORTO, PORTO (PT)

(72) Inventors: Diamantino Rui DA SILVA FREITAS, Porto (PT); Bruno CATARINO BISPO, Porto (PT)

(73) Assignee: UNIVERSIDADE DO PORTO, Porto (PT)

(21) Appl. No.: 15/320,065

(22) PCT Filed: Sep. 26, 2014
(86) PCT No.: PCT/IB2014/064883

§ 371 Date: Dec. 19, 2016

(30) Foreign Application Priority Data
Sep. 26, 2013 (PT) 107190

(51) Int. Cl. H04R 3/02; H04R 3/00; G10L 25/24

(52) U.S. Cl. CPC H04R 3/02; G10L 25/24; H04R 3/005

(57) ABSTRACT

The present disclosure relates to a circuit and method for cancelling the acoustic feedback in public address systems, sound reinforcement systems, hearing aids, teleconference systems or hands-free communication systems, comprising providing a filter for tracking the acoustic feedback path between the radiator device broadcasting and the receiver device, the input of said filter being the signal applied to the radiator device; updating the filter for tracking the acoustic feedback path based on time-domain information contained in the cepstrum of the receiver device signal, or updating the filter for tracking the acoustic feedback path based on time-domain information contained in the cepstrum of the signal applied to the radiator device, or updating the filter for tracking the acoustic feedback path based on time-domain information contained in the cepstrum of the difference between the receiver device signal and the signal applied to the radiator device filtered by the filter.

### TECHNICAL FIELD

The present disclosure relates to a circuit and method for cancelling the acoustic feedback in public address systems, sound reinforcement systems, hearing aids, teleconference systems or hands-free comunication systems.

### BACKGROUND

The acoustic coupling from loudspeakers to microphones, that generally occurs in the environment where these devices operate, causes the loudspeaker sound signal, voice or music, to be picked up by the microphone and returned into the communication system. The existence of this acoustic feedback is inevitable and may generate annoying effects that disturb the communication or even make it impossible [1-3].

In a typical public address (PA) system or reinforcement system, a speaker employs these devices along with an amplification system to apply a gain on his/her voice signal aiming to be heard by a large audience in the same acoustic environment. The speaker's speech signal v(n), after being picked up by the microphone, amplified and played back by the loudspeakers, may return to the microphone going through several paths. Such a system is illustrated in FIG. 1 for only one microphone and one loudspeaker.

Among these paths are included the direct one, if it exists, as well as the ones given by a large number of reflections. In all cases there is some signal attenuation which becomes more intense with the increase in path length and thus only a finite number of reflections need to be considered in the feedback path. For simplicity, the feedback path also includes the characteristics of the D/A converter, loudspeaker, microphone and A/D converter. Although some non-linearities may occur because of loudspeaker saturation, almost invariably it is considered that the feedback path is linear. Hence, the acoustic feedback path is usually defined as a time-variant finite impulse response (FIR) filter

$$\begin{matrix}F ( z , n ) = f ( 0 , n ) + f ( 1 , n ) {z}^{- 1} + … + f ( {L}_{F} - 1 , n ) {z}^{- ( {L}_{F} - 1 )} \\ = \begin{matrix}[ f ( 0 , n ) & f ( 1 , n ) & … & f ( {L}_{F} - 1 , n ) ]\end{matrix} [ \begin{matrix}1 \\ {z}^{- 1} \\ ⋮ \\ {z}^{- ( {L}_{F} - 1 )}\end{matrix} ] \\ = f ( m , n ) ⊗ z ( m ) , m = 0 , … , {L}_{F} - 1\end{matrix} \qquad ( 1 )$$

with length L_{F} and where 0 denotes element-wise multiplication. The vector f(m,n) is the impulse response and has a constant length but all its values may vary over time. Therefore, in f(m,n), the discrete-time or iteration index n differs from its sample index m.

The forward path includes the characteristics of the amplifier as well as of any other signal processing device inserted in the signal loop, such as an equalizer. Moreover, it also includes a time delay of L_{D}−1 samples which is often unavoidable in digital implementations. This time delay may be implemented by a delay filter with length L_{D}, highpass filter, lowpass filter, etc. Once again, although some non-linearities may exist because of compression, the forward path is usually assumed to be linear and defined as an FIR filter

$$\begin{matrix}G ( z , n ) = g ( 0 , n ) + g ( 1 , n ) {z}^{- 1} + … + g ( {L}_{G} - 1 , n ) {z}^{- ( {L}_{G} - 1 )} \\ = g ( m , n ) ⊗ z ( m ) , m = 0 , … , {L}_{G} - 1\end{matrix} \qquad ( 2 )$$

with length L_{G}≧L_{D}.

Let the system input signal u(n) be the source signal v(n) added to the ambient noise signal r(n), i.e., u(n)=v(n)+r(n), and, for simplicity, also include the characteristics of the microphone and A/D converter. The system input signal u(n) and the loudspeaker signal x(n) are related by the PA system closed-loop transfer function as

$$X ( z ) = \frac{G ( z , n )}{1 - G ( z , n ) F ( z , n )} U ( z ) . \qquad ( 3 )$$

According to the Nyquist's stability criterion, the closed-loop system is unstable if there is at least one frequency ω such that [5]

$$\{ \begin{matrix}\vert G ( {e}^{j ω} , n ) F ( {e}^{j ω} , n ) \vert \geq 1 \\ ∠ G ( {e}^{j ω} , n ) F ( {e}^{j ω} , n ) = 2 k π , k ∈ Z\end{matrix} . \qquad ( 4 )$$

It means that if at least one frequency component is reinforced after traversing the system open-loop transfer function G(z,n)F(z,n) and added to the input signal u(n) with a phase shift of 2kπ, this frequency component will never disappear from the system even if there is no more input signal. After each loop through the system, its amplitude will increase causing a howling at that frequency, a phenomenon known as Larsen effect [1-3]. This howling will be very annoying for all the audience and the system gain (imposed by G(z,n)) generally has to be reduced. As a consequence, the maximum stable gain (MSG) of the PA system is limited by the occurrence of acoustic feedback [1-3].

In order to eliminate or, at least, to control the Larsen effect, several methods have been developed over the past decades [3]. However, the most common suppression techniques have inherent problems that limit their effectiveness [3]. For instance, Phase Modulation and Frequency Shifting have a very limited MSG before effects are audibly noticeable[3]. Notch Filtering takes in general a reactive approach that only acts after howling is heard, which affects the sound quality, and it can only suppress a small number of frequencies that agree with Nyquist's stability criterion [3].

On the other hand, Acoustic Feedback Cancellation (AFC) methods identify and track the acoustic feedback path F(z,n) using an adaptive filter that is generally defined as an FIR filter

$$\begin{matrix}H ( z , n ) = h ( 0 , n ) + h ( 1 , n ) {z}^{- 1} + … + h ( {L}_{H} - 1 , n ) {z}^{- ( {L}_{H} - 1 )} \\ = h ( m , n ) ⊗ z ( m ) , m = 0 , … , {L}_{H} - 1\end{matrix} \qquad ( 5 )$$

with length L_{H}. Then, the feedback signal f(m,n)*x(n) is estimated as h(m,n)*x(n) and subtracted from the microphone signal y(n) so that, ideally, only the system input signal u(n) is processed by the forward path G(z,n). Such a scheme is shown in FIG. 2.

But, owing to the presence of the forward path G(z,n), the estimation noise (system input u(n)) and input (loudspeaker x(n)) signals for the adaptive filter are highly correlated. Then, if the traditional adaptive filtering algorithms based on the Wiener theory or least squares are used, a bias is introduced in the estimate of the acoustic feedback path [1-3,8]. As undesired consequences, the adaptive filter H(z,n) only partially cancels the feedback signal f(m,n)*x(n) and also applies distortions to the system input signal u(n).

The bias problem occurs when direct closed-loop identification is applied [1-3,8]. Direct closed-loop identification methods do not require the presence of any extra probe signal (as noise) that could be inserted in the system, and identify the feedback path F(z,n) using only measurements of the system signals [3,8].

Mostly, the solutions existing in the literature to overcome the bias in the estimate of the feedback path try to decorrelate the loudspeaker x(n) and system input u(n) signals but still using the traditional adaptive filtering algorithms. Some methods do not use direct closed-loop identification and insert a processing block in the forward path G(z,n) aiming to change the waveform of the loudspeaker signal x(n) and then reduce the cross-correlation. The processing block inserted in the system must not perceptually affect the quality of the signals which is particularly difficult to achieve. Other methods apply processing to the system signals only to create auxiliary versions that are used to update the adaptive filter. These methods do not modify the signals that travel in the system and therefore are classified as direct closed-loop identification methods.

Among the non-direct closed-loop identification methods, several solutions proposed to add a noise signal to the loudspeaker signal. Using both noise injection and filter adaptation continuous in time, white noise and noise with specific properties, aiming to reduce the noise perception or to improve the system performance, were used [3]. Using both noise injection and filter adaptation non-continuous in time, white noise was also used either when instability is detected or when the source signal level is low [3].

The inclusion of a half-wave rectifier function in G(z,n) in order to insert non-linearities between the source and loudspeaker signals was already tried [3]. The insertion of delays in the forward or cancellation path was also proposed [3]. The insertion of frequency shifting and phase modulation in G(z,n) were also proposed to decorrelate the system input and loudspeaker signals in AFC systems [3-5].

With respect to direct closed-loop identification methods, it was proved that the bias in the feedback path estimate can be eliminated using the prediction error method (PEM) [1-3]. The PEM considers that the noise signal for the estimation process (system input u(n) in the AFC case) is modeled as the output of a filter whose input is a white noise signal with zero mean, which fits quite well for voiceless segments of speech signals. Then, the idea consists on pre-filtering the loudspeaker and microphone signals with the inverse source model in order to obtain whitened versions of them, and use these whitened signals to update the adaptive filter according to some traditional adaptive filtering algorithm.

In [8], a fixed source model was used. In [2,9], the prediction error method based adaptive feedback canceller (PEM-AFC) used an adaptive filter to estimate the source model continuously over time. In [1, 3,10], the prediction error method based on adaptive filtering with row operations (PEM-AFROW) method improved the PEM-AFC and extended it for long acoustic paths replacing the adaptive filter by the well-known Levinson-Durbin algorithm in the estimation of the source model. Moreover, after applying the inverse source model to obtain the whitened versions of the microphone and loudspeaker signals, the PEM-AFROW method also applied a processing to remove the pitch components in order to improve its performance for voiced segments of speech signals [1, 3]. It should be noted that, when replacing the adaptive filter by the Levinson-Durbin algorithm in the estimation of the source model, the PEM-AFROW method became suitable mostly for speech signals. The PEM-AFROW was combined with generalized sidelobe canceller but its performance did not improve for long feedback paths that occur in PA systems [3].

### General Description

The present disclosure proposes a circuit and method for cancelling the acoustic feedback in public address systems, sound reinforcement systems, hearing aids, teleconference systems or hands-free comunication systems.

The present disclosure relates to a method for cancelling the acoustic feedback feedback in public address systems, sound reinforcement systems, hearing aids, teleconference systems or hands-free comunications systems, comprising the steps of

1. applying the signal x(n) to a filter H(z, n) and to a radiating device, e.g. a loudspeaker, broadcasting in an environment.

2. picking up by means of a receiver device, e.g. a microphone, a signal y(n) from the environment, comprising the feedback signal f(m,n)*x(n) (broadcasted signal filtered by the feedback path) and an input signal u(n).

3. computing the signal e(n) as the difference between the signal y(n) picked up with the receiver device and a version of the signal x(n) filtered by the filter H(z,n), h(m,n)*x(n).

According to the disclosure, the method is characterised in that it comprises the steps of:

calculating the cepstrum c_{y}(τ,n) of the signal y(n).

calculating a time-domain signal p_{y}(m,n) from c_{y}(τ,n).

calculating an update of the coefficients of the filter H(z,n) taking into account p_{y}(m,n) from the previous step.

copying the filter's updated coefficients into the filter H(z,n).

applying the signal e(n) to the forward path G(z,n) to update the signal x(n).

In a preferred embodiment the steps of the method are performed repeatedly. Preferably the signal y(n) is divided in frames.

### BRIEF DESCRIPTION OF THE DRAWINGS

The following figures provide preferred embodiments for illustrating the description and should not be seen as limiting the scope of disclosure.

FIG. 1 shows a representation of the acoustic feedback in a PA system.

FIG. 2 shows a representation of the acoustic feedback cancellation based on the traditional adaptive filtering algorithms.

FIG. 3 shows a representation of the acoustic feedback cancellation based on cepstral analysis of the microphone signal.

FIG. 4 shows a representation of the block diagram of the present disclosure.

FIG. 5 shows a representation of the possible block diagram of the present disclosure.

FIG. 6 shows a representation of the impulse response of the feedback path.

FIG. 7 shows a representation of the comparison between the average misalignment of the PEM-AFROW and Cepstrum-based methods for speech signal.

FIG. 8 shows a representation of the acoustic feedback cancellation based on cepstral analysis of the error signal.

FIG. 9 shows a representation of the acoustic feedback cancellation based on cepstral analysis of the error signal.

FIG. 10 shows a representation of the acoustic feedback cancellation based on cepstral analysis of the system signals.

FIG. 11 shows a representation of the block diagram of the present disclosure: (a) using only the error signal; (b) using only the loudspeaker signal; (c) combined the microphone, error and loudspeaker signals.

FIG. 12 shows a representation of the possible block diagram of the present disclosure: (a) using only the error signal; (b) using only the loudspeaker signal; (c) combined the microphone, error and loudspeaker signals.

FIG. 13 shows a representation of the performance comparison for: (a) MSG; (b) MIS.

FIG. 14 shows a representation of the performance comparison for dB: (a) MSG; (b) MIS.

FIG. 15 shows a representation of the performance comparison for dB: (a) MSG; (b) MIS.

FIG. 16 shows a representation of the performance of the present disclosure for dB: (a) MSG; (b) MIS.

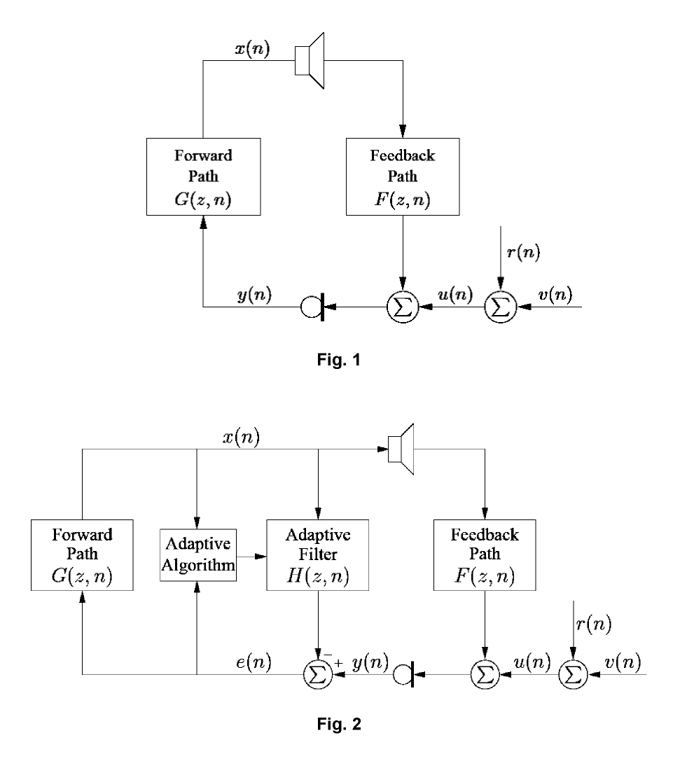

### DETAILED DESCRIPTION

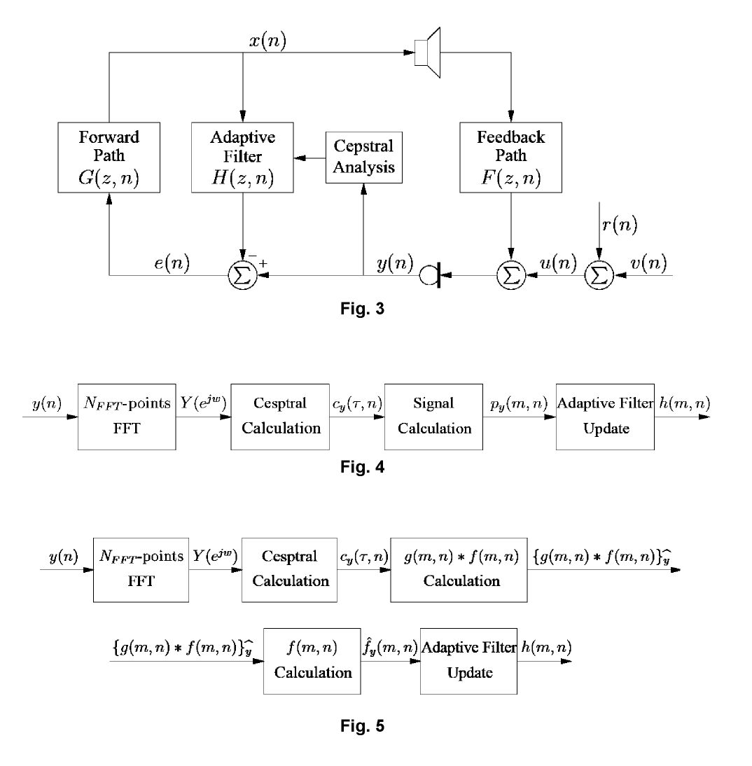

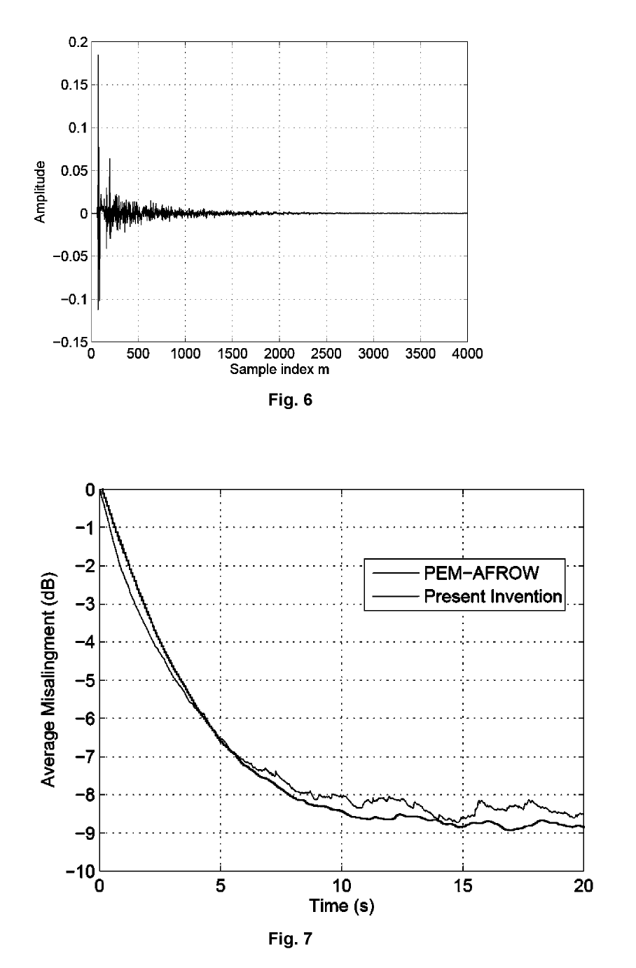

As any AFC method, the present disclosure identifies and tracks the feedback path using an adaptive filter. But, instead of the traditional adaptive filter algorithms based on Wiener theory or least squares, the present disclosure updates the adaptive filter based on time-domain information contained in the cepstrum of the microphone signal and such a scheme is illustrated in FIG. 3.

The system depicted in FIGS. 2 and 3 is described by the following time-domain equations

$$\{ \begin{matrix}y ( n ) = u ( n ) + f ( m , n ) * x ( n ) \\ e ( n ) = y ( n ) - h ( m , n ) * x ( n ) \\ x ( n ) = g ( m , n ) * e ( n )\end{matrix} \qquad ( 6 )$$

and their respective representations in the frequency-domain

$$\{ \begin{matrix}Y ( {e}^{jw} ) = U ( {e}^{jw} ) + F ( {e}^{jw} , n ) X ( {e}^{jw} ) \\ E ( {e}^{j ω} ) = Y ( {e}^{j ω} ) - H ( {e}^{j ω} , n ) X ( {e}^{j ω} ) \\ X ( {e}^{j ω} ) = G ( {e}^{j ω} , n ) E ( {e}^{j ω} )\end{matrix} \qquad ( 7 )$$

From (7), the frequency-domain realationship between the system input signal u(n) and the microphone signal y(n) is obtained as

$$Y ( {e}^{j ω} ) = \frac{1 + G ( {e}^{j ω} , n ) H ( {e}^{j ω} , n )}{1 - G ( {e}^{j ω} , n ) [ F ( {e}^{j ω} , n ) - H ( {e}^{j ω} , n ) ]} U ( {e}^{j ω} ) , \qquad ( 8 )$$

which applying the natural logarithm becomes

ln└(e^{jω})┘=ln└U(e^{jω})┘+ln└1+G(e^{jω},n)H(e^{jω},n)┘−ln{1−G(e^{jω},n)[F(e^{jω},n)−H(e^{jω},n)]} (9)

If |G(e^{jω},n)H(e^{jω},n)|>1, the middle term in (9) can be expanded in Taylor's series according to

$$ln [ 1 + G ( {e}^{j ω} , n ) H ( {e}^{j ω} , n ) ] = {\sum }_{k = 1}^{∞} {( - 1 )}^{k + 1} \frac{{[ G ( {e}^{j ω} , n ) H ( {e}^{j ω} , n ) ]}^{k}}{k} , \qquad ( 10 )$$

and if |G(e^{jω})[F(e^{jω})−H(e^{jω},n),]<1, which is the necessary and sufficient condition to ensure the system stability, the rightmost term can also be expanded in Taylor's series according to

$$ln \{ 1 - G ( {e}^{j ω} ) ⌊ F ( {e}^{j ω} ) - H ( {e}^{j ω} , n ) ⌋ \} = - {\sum }_{k = 1}^{∞} \frac{{\{ G ( {e}^{j ω} ) [ F ( {e}^{j ω} ) - H ( {e}^{j ω} , n ) ] \}}^{k}}{k} . \qquad ( 11 )$$

Replacing (10) and (11) in (9), and applying the inverse Fourier transform as follows

$${F}^{- 1} \{ ln [ Y ( {e}^{j ω} ) ] \} = {F}^{- 1} \{ ln [ U ( {e}^{j ω} ) ] \} + {F}^{- 1} \{ {\sum }_{k = 1}^{∞} {( - 1 )}^{k + 1} \frac{{[ G ( {e}^{j ω} , n ) H ( {e}^{j ω} , n ) ]}^{k}}{k} \} + {F}^{- 1} \{ {\sum }_{k = 1}^{∞} \frac{{\{ G ( {e}^{j ω} , n ) [ F ( {e}^{j ω} , n ) - H ( {e}^{j ω} , n ) ] \}}^{k}}{k} \} , \qquad ( 12 )$$

the cepstral-domain relationship between the input signal u(n) and the microphone signal y(n) is obtained as

$${c}_{y} ( τ , n ) = {c}_{u} ( τ ) + {\sum }_{k = 1}^{∞} \frac{{g ( m , n )}^{* k}}{k} * \{ {[ f ( m , n ) - h ( m , n ) ]}^{* k} + {( - 1 )}^{k + 1} {h ( m , n )}^{* k} \} \qquad ( 13 )$$

where τ is the quefrency index and {.}*^{k} denotes the k th convolution power.

In the system depicted in FIG. 3, the cepstrum c_{y}(τ,n) of the microphone signal is the cepstrum cᵤ(τ) of the input signal added to a time-domain series in function of g(m,n), f(m,n) and h(m,n). The presence of this time-domain series is due to the disappearance of the logarithm operator in the last two terms of (12). So, for these series in (13), the sample index m is equivalent to the quefrency index τ, i.e., f(m,n)=f(τ,n). But, in order to emphasize that it is a time-domain series, it is represented in (19) by the sample index in. This series is formed by k-fold convolutions of g(m,n)*h(m,n) and g(m,n)*[f(m,n) h(m,n)] Therefore, it is crucial to understand that the cepstrum c_{y}(τ,n) of the microhpne signal contains time-domain information about the AFC system of FIG. 3 through G(z,n), F(z,n) and H(z,n).

However, the practical existence of these time-domain impulse responses in c_{y}(τ,n) depends on the number of points wherewith c_{y}(τ,n) is calculated and also if the size of the time-domain observation window is large enough to include their effects. Morever, it is crucial to realize that, regardless of the value of h(m,n), the open-loop impulse response g(m,n)*f(m,n) is always present in c_{y}(τ,n).

The functional scheme of the present disclosure is depicted in FIG. 4. An observation window of the microphone signal y(n) has its spectrum Y(e^{jω}) and cepstrum c_{y}(τ,n) calculated using a N_{FFT}-points Fast Fourier Transform (FFT). Then, the present disclosure calculates a time-domain signal p_{y}(m,n) from c_{y}(τ,n). In fact, the time-domain signal p_{y}(m,n) is calculated from the time-domain series present in c_{y}(τ,n) according to (13). Finally, the time-domain signal p_{y}(m,n) is used to update the filter H(z,n).

The contents of the time-domain signal p_{y}(m,n) may be varied as well as the way it is calculated from c_{y}(τ,n). A possible solution is depicted in FIG. 5, in which p_{y}(m,n) is an estimate \hat{f}_{y}(m,n)of the impulse response of the acoustic feedback path.

For that purpose, the present disclosure may calculate {g(m,n)*f(m,n)}\hat{_{y}}, an estimate of the system open-loop impulse response g(m,n*f(m,n), from c_{y}(τ,n). This calculation can be performed by selecting the first L_{G}+L_{H} samples from c_{y}(τ,n) and making their first L_{D}−1 samples equal to zero. Alternatively, this calculation can be performed by selecting the samples of c_{y}(τ,n) that has a magnitude value above a threshold and also making their first L_{D}−1 samples equal to zero.

The forward path G(z,n) can be accurately calculated from its input (e(n)) and output (x(n)) signals by any open-loop system identification method. Then, assuming the existence of an estimate ĝ(m,n) of the forward path impulse response, the present disclosure may calculate \hat{f}_{y}(m,n), an instantaneous estimate of the impulse response f(m,n) of the feedback path, according to

f_{y}(m,n)={g(m,n)*f(m,n)}\hat{_{y}}*ĝ⁻¹(m,n). (14)

Finally, the present disclosure may use \hat{f}_{y}(m,n) to update the filter H(z,n). The update of H(z,n) may be performed according to

h(m,n)=λh(m,n−1)+(1−λ)\hat{f}_{y}(m,n), (15)

where 0≦λ<1 is a factor that controls the trade-off between robustness and tracking rate.

To assess the performance of the proposed method in a PA system, an experiment was made to measure the accuracy of its estimate of the impulse response of the feedback path in a simulated environment. For this purpose, the following configuration was used.

In order to simulate a PA environment, a measured room impulse response, from [6], was used as the impulse response f(m,n) of the acoustic feedback path. The impulse response was downsamples to fₓ=16 kHz and then truncated to length L_{F}=4000 samples, and is illustrated in FIG. 3

The impulse response of the forward path was defined as simply defined as a delay and a gain according to

g(m,n)=[0 0 . . . 0 g(402, n)]. (16)

The gain g(402,n) was chosen such that the system had a stable gain margin of 3 dB. As sugested in [1,3], the delay is equivalent to 25 ms.

The performance of the adaptive filter was evaluated by the normalized misalignment defined as

$$MIS ( n ) = \frac{‖ f ( m , n ) - h ( m , n ) ‖}{‖ f ( m , n ) ‖} , \qquad ( 17 )$$

that measures how near the estimate h(m,n) is of the real f(m,n).

The signal database used in the following simulations is formed by 10 speech signals. Each speech signal is formed by several basic signals from a speech database. Each basic signal consists of one short sentence with duration of 4 s and original sampling rate of 48 kHz but downsampled to fₛ=16 kHz. All basic signals were recorded in the talkers' native language, and their nationalities and genders follow: 4 Americans (2 males and 2 females), 2 British (1 male and 1 female), 2 French (1 male and 1 female) and 2 Germans (1 male and 1 female).

But since the performance assessment of adaptive filters needs longer signals, several basic signals from the same talker were concatenated and had their silence parts removed by a voice activity detector (VAD), resulting in 10 speech signals (1 signal by talker) with duration of Tₛ=20 s.

The values of λ and L_{H} were chosen empirically, within a pre-defined range, in order to minimize the average misalignment and N_{FFT}=2¹⁵ samples. The method started only after 12.5 ms of simulation to avoid inaccurate initial estimates

For performance comparison using speech as source signal, the state-of-art PEM-AFROW method was used. All its parameters had the same values as originally proposed in [1], but adjusted to fₛ=16 kHz. The stepsize and length of the adaptive filter were also obtained empirically in order to minimize the average misalignment.

FIG. 7 compares the average misalignments obtained by both methods using speech signal as source and a source-signal-to-noise (SNR) of 30 dB. As can be seen, the present disclosure obtained a lower misalignment, what means that it achieved an improvement in the estimation of the impulse response of the feedback path when compared to the state-of-art PEM-AFROW method. The small advantage of the PEM-AFROW in the low time is explained by the fact that, unlike the present disclosure, the PEM-AFROW is applied since the beginning of the simulation.

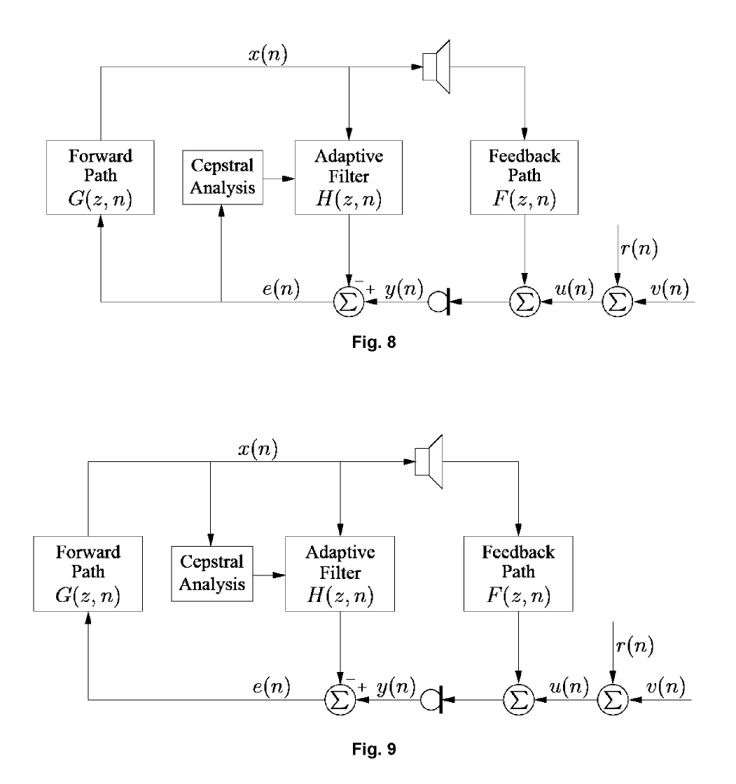

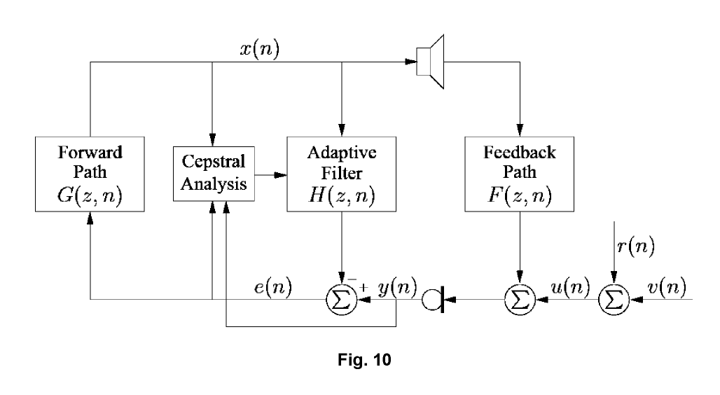

Further, the same cepstral analysis, that was applied to the microphone signal y(n), is also extended to the error e(n) and loudspeaker x(n) signals. As a result, the present disclosure discloses a circuit and method wherein the acoustic feedback cancellation is performed in an alternative fashion. More specifically, the method disclosed in the present disclosure calculates, from the cepstra of the system signals, time-domain signals that can be, for instance, estimates of the environment impulse response. These time-domain signals can be used separately, as in FIGS. 3, 8 and 9, or combined, as in FIG. 10, to update a filter that is responsible for cancelling the acoustic feedback.

The method is capable to outperform existing methods. The main difference with prior art schemes is twofold. First, there is no assumption on the nature of the system input signal u(n). Second, in addition to the feedback removal, the present disclosure does not modify the signals that circulate in the system and thus does not affect the main system fidelity. Furthermore, the method can be implemented in real-time because of its low computacional complexity.

From (7), the frequency-domain relationships between the system input signal u(n) and the error e(n) and loudspeaker x(n) signals are, respectively, obtained as

$$\begin{matrix}E ( {e}^{j ω} ) = \frac{1}{1 - G ( {e}^{j ω} , n ) [ F ( {e}^{j ω} , n ) - H ( {e}^{j ω} , n ) ]} U ( {e}^{j ω} ) \\ and & ( 18 ) \\ X ( {e}^{j ω} ) = \frac{G ( {e}^{j ω} , n )}{1 - G ( {e}^{j ω} , n ) [ F ( {e}^{j ω} , n ) - H ( {e}^{j ω} , n ) ]} U ( {e}^{j ω} ) . & ( 19 )\end{matrix}$$

Applying the natural logarithm, (26) and (27) become

ln└E(e^{jω})=ln└U(e^{jω})┘−ln{1−G(e^{jω},n)└F(e^{jω},n)−H(e^{jω},n)┘} (20)

and

ln└X(e^{jω})┘=ln└U(e^{jω})┘+ln└G(e^{jω},n)┘−ln{1−G(e^{jω},n)[F(e^{jω},n)−H(e^{jω},n)]} (21)

If |G(e^{jω})[F(e^{jω})−H(e^{jω},n),]>1, which is the necessary and sufficient condition to ensure the system stability, the rightmost term in (20) and (21) can be expanded in Taylor's series according to (11).

Replacing (11) in (20) and (21), and applying the inverse Fourier transform as follows

$$\begin{matrix}{F}^{- 1} \{ ln [ E ( {e}^{j ω} ) ] \} = {F}^{- 1} \{ ln [ U ( {e}^{j ω} ) ] \} + {F}^{- 1} \{ {\sum }_{k = 1}^{∞} \frac{{\{ G ( {e}^{j ω} , n ) [ F ( {e}^{j ω} , n ) - H ( {e}^{j ω} , n ) ] \}}^{k}}{k} \} , & ( 22 ) \\ {F}^{- 1} \{ ln [ X ( {e}^{j ω} ) ] \} = {F}^{- 1} \{ ln [ U ( {e}^{j ω} ) ] \} + {F}^{- 1} \{ ln [ G ( {e}^{j ω} , n ) ] \} + {F}^{- 1} \{ {\sum }_{k = 1}^{∞} \frac{{\{ G ( {e}^{j ω} , n ) [ F ( {e}^{j ω} , n ) - H ( {e}^{j ω} , n ) ] \}}^{k}}{k} \} , & ( 23 )\end{matrix}$$

the cepstral-domain relationships between the input signal u(n) and error e(n) and loudspeaker x(n) signals are, respectively, obtained as

$$\begin{matrix} {c}_{e} ( τ , n ) = {c}_{u} ( τ ) + {\sum }_{k = 1}^{∞} \frac{{\{ g ( m , n ) * [ f ( m , n ) - h ( m , n ) ] \}}^{* k}}{k} \\ and & ( 24 ) \\ {c}_{x} ( τ , n ) = {c}_{u} ( τ ) + {c}_{g} ( τ , n ) + {\sum }_{k = 1}^{∞} \frac{{\{ g ( m , n ) * [ f ( m , n ) - h ( m , n ) ] \}}^{* k}}{k} . & ( 25 )\end{matrix}$$

The cepstrum cₑ(τ,n) of the signal e(n) is the cepstrum cᵤ(τ) of the signal u(n) added to a time-domain series in function of g(m,n), f(m,n) and h(m,n). The cepstrum cₓ(τ,n) of the signal x(n) also includes the cepstrum c_{g}(τ) of the forward path G(z,n). In cₑ(τ,n) and cₓ(τ,n), the presence of the time-domain series are due to the disappearance of the logarithm operators in the rightmost term of (22) and (23), respectively.

So, for these series in (24) and (25), the sample index m is equivalent to the quefrency index τ, i.e., f(m,n)=f(τ,n). But, in order to emphasize that they are time-domain series, they are represented in (24) and (25) by the sample index m. These series are formed by k-fold convolutions g(m,n)*[f(m,n)−h(m,n)]. Therefore, the cepstra cₑ(τ,n) and cₓ(τ,n) contain time-domain information about the AFC system through G(z,n), F(z,n) and H(z,n).

However, the practical existence of these time-domain impulse responses in cₑ(τ,n) and cₓ(τ,n) depends on the number of points wherewith cₑ(τ,n) and cₓ(τ,n) are calculated and also if the size of the time-domain observation windows is large enough to include their effects.

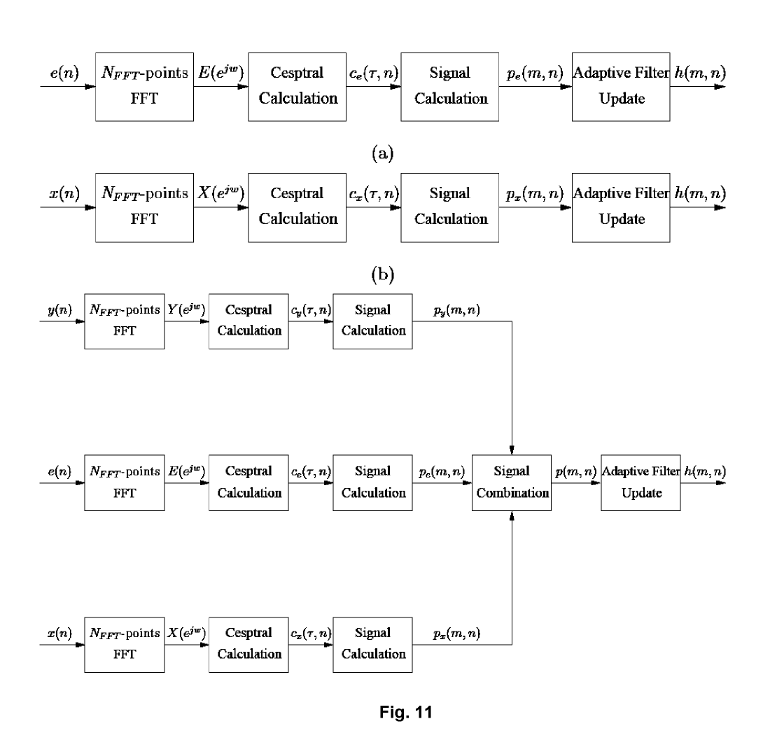

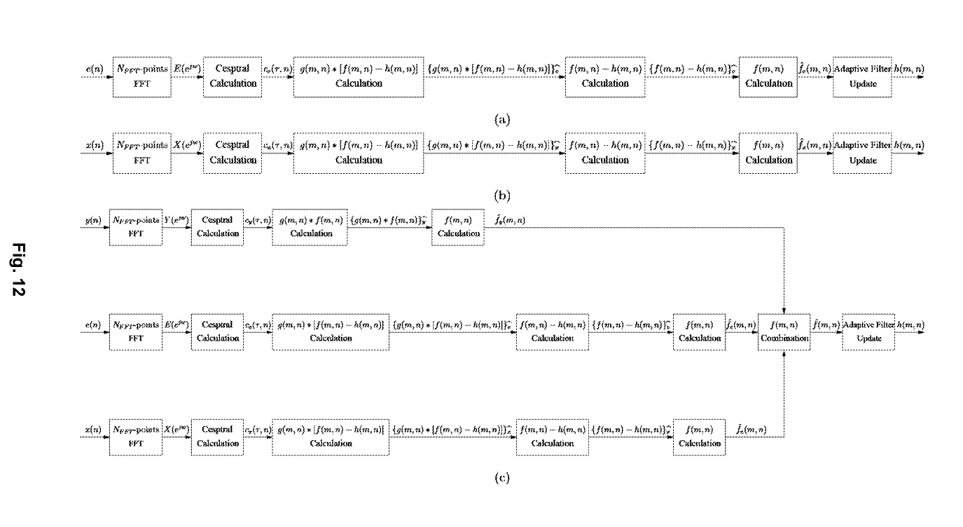

The functional scheme of the present disclosure is depicted in FIG. 11. From FIG. 11(a), an observation window of the error signal e(n) has its spectrum E(e^{jω}) and cepstrum cₑ(τ,n) calculated using a N_{FFT}-points Fast Fourier Transform (FFT). Then, the present disclosure calculates the time-domain signal pₑ(m,n) from cₑ(τ,n). In fact, the time-domain signal pₑ(m,n) may be calculated from the time-domain series present in cₑ(τ,n) according to (24). Finally, the time-domain signal pₑ(m,n) is used to update the filter H(z,n).

From FIG. 11(b), an observation window of the loudspeaker signal x(n) has its spectrum X(e^{jω}) and cepstrum cₓ(τ,n) calculated using a N_{FFT}-points Fast Fourier Transform (FFT). Then, the present disclosure calculates the time-domain signal pₓ(m,n) from cₓ(τ,n). In fact, the time-domain signal pₓ(m,n) is calculated from the time-domain series present in cₓ(τ,n) according to (25). Finally, the time-domain signal pₓ(m,n) is used to update the filter H(z,n).

Alternatively, as depicted in FIG. 11(c), the time-domain signals p_{y}(m,n), pₑ(m,n) and pₓ(m,n) can be combined to update the filter H(z,n). This can be performed through, for instance, a linear combination. The contents of the time-domain signal pₑ(m,n) may be varied as well as the way it is calculated from cₑ(τ,n). A possible solution is depicted in FIG. 12(a), in which pₑ(m,n) is an estimate \hat{f}ₑ(m,n) of the impulse response of the acoustic feedback path.

For that purpose, the present disclosure may calculate {g(m,n)*[f(m,n)−h(m,n)]}\hat{ₑ}, an estimate of the estimation error g(m,n)*[f(m,n)−h(m,n)] of the open-loop impulse response provided by the filter H(z,n), from cₑ(τ,n). This calculation can be performed by selecting the first L_{G}+L_{H} samples from cₑ(τ,n) and making their first L_{D}−1 samples equal to zero. Alternatively, this calculation can be performed by selecting the samples of cₑ(τ,n) that has a magnitude value above a threshold and also making their first L_{D}−1 samples equal to zero.

The forward path G(z,n) can be accurately estimated from its input (e(n)) and output (x(n)) signals by any open-loop system identification method. Then, assuming the existence of an estimate ĝ(m,n) of the forward path impulse response, the present disclosure may calculate [f(m,n)−h(m,n)]\hat{ₑ}, an estimate of the estimation error f(m,n)−h(m,n) of the feedback path provided by the adaptive filter H(z,n), according to

[f(m,n)−h(m,n)]ₑ={g(m,n)*[f(m,n)−h(m,n)]}\hat{ₑ}*ĝ⁻¹(m,n). (34)

Thereafter, the present disclosure may calculate \hat{f}ₑ(m,n), an instantaneous estimate of the impulse response f(m,n) of the feedback path, from (34) according to

\hat{f}ₑ(m,n)=[f(m,n)−h(m,n)]\hat{ₑ}+h(m,n−1). (35)

Finally, the present disclosure may use \hat{f}ₑ(m,n) to update the filter H(z,n). The update of H(z,n) may be performed according to

h(m,n)=λh(m,n−1)+(1−λ)fₑ(m,n), (23)

where 0≦λ<1 is a factor that controls the trade-off between robustness and tracking rate. Similarly, the contents of the time-domain signal pₓ(m,n) may be varied as well as the way it is calculated from cₓ(τ,n). A possible solution is depicted in FIG. 12(b), in which pₛ(m,n) is an estimate \hat{f}ₓ(m,n) of the impulse response of the acoustic feedback path.

For that purpose, the present disclosure may calculate {g(m,n)*[f(m,n)−h(m,n)]}\hat{ₓ}, an estimate of the estimation error g(m,n)*[f(m,n)−h(m,n)] of the open-loop impulse response provided by the filter H(z,n), from cₓ(τ,n). This calculation can be performed by selecting the first L_{G}+L_{H} samples from cₓ(τ,n) and making their first L_{D}−1 samples equal to zero. Alternatively, this calculation can be performed by selecting the samples of c(z,n) that has a magnitude value above a threshold and also making their first L_{D}−1 samples equal to zero.

Assuming the existence of an estimate ĝ(m,n) of the forward path impulse response, the present disclosure may calculate [f(m,n)−h(m,n)]\hat{ₓ}, an estimate of the estimation error f(m,n)−h(m,n) of the feedback path provided by the adaptive filter H(z,n), according to

[f(m,n)−h(m,n)]\hat{ₓ}={g(m,n)*[f(m,n)−h(m,n)]}\hat{ₓ}*g⁻¹(m,n). (34)

Thereafter, the present disclosure may calculate \hat{f}ₓ(m,n), an instantaneous estimate of the impulse response f(m,n) of the feedback path, from (34) according to

\hat{f}ₓ(m,n)=[f(m,n)−h(m,n)]\hat{ₓ}+h(m,n−1). (35)

Finally, the present disclosure may use \hat{f}ₓ(m,n) to update the filter H(z,n). The update of H(z,n) may be performed according to

h(m,n)=λh(m,n−1)+(1−λ)\hat{f}ₓ(m,n), (36)

where 0≦λ<1 is a factor that controls the trade-off between robustness and tracking rate.

The present disclosure was evaluated through the misalignment (MIS) and the maximum stable gain (MSG). The MIS(n) measures the distance between the impulse responses of the adaptive filter and of the feedback path according to (25).

In order to measure the maximum stable gain of the PA system, a broadband gain K(n) was defined, similarly to [3], as the average magnitude of the forward path frequency response G(e^{jω},n)

$$K ( n ) = \frac{1}{2 π} {\sum }_{ω = 0}^{2 π} \vert G ( {e}^{j ω} , n ) \vert , \qquad 37 )$$

and is extracted from G(z,n) by

G(z,n)=K(n)J(z,n). (38)

Considering that J(z,n) is known, the maximum stable gain (MSG) of the AFC system was defined as

$$\begin{matrix} MSG ( n ) ( dB ) = 20 {log}_{10} K ( n ) \\ such that {max}_{ω ∈ {P}_{H} ( n )} \vert G ( {e}^{j ω} , n ) [ F ( {e}^{j ω} , n ) - H ( {e}^{j ω} , n ) ] \vert = 1 , \\ resulting in & ( 39 ) \\ MSG ( n ) ( dB ) = - 20 {log}_{10} [ {max}_{ω ∈ {P}_{H} ( n )} \vert J ( {e}^{j ω} , n ) [ F ( {e}^{j ω} , n ) - H ( {e}^{j ω} , n ) ] \vert ] , & ( 40 )\end{matrix}$$

where P_{H} denotes the set of frequencies that fulfill the phase condition of the system with the insertion of the adaptive filter, also called critical frequencies of the AFC system, so that

P_{H}(n)={ω|∠G(e^{jω},n)└F(e^{jω}, n)┘=2kπ,k∈Z} (41)

The increase in MSG(n) achieved by the AFC methods was denoted as ΔMSG(n). The MSG of the system with no AFC method was defined as MSG₀=20 log₁₀K₀. K(n) was initialized to a value K₁ such that 20 log₁₀K₁=MSG₀−3, i.e., a 3 dB initial gain margin as suggested in [3], in order to allow the AFC method to operate in a stable condition and thus the adaptive filter to converge.

In a first configuration, K(n) remained with the same value, K(n)=K₁, during all the simulation time T=20 s in order to verify the methods' performance for a time-invariant forward path G(z,n). In a more practical configuration, K(n)=K₁ until 5 s and then 20 log₁₀K(n) was increased at the rate of 1 dBs up to 20 log₁₀ K₂ such that 20 log₁₀K₂=20 log₁₀K₁+ΔK. Finally, K(n)=K₂ during 10 s totaling a simulation time T=15+ΔKs. The maximum increase in the broadband gain ΔK that can be allowed while maintaining a stable operation (which should not be confused with the MSG) differs depending on which method is being used.

The performance of the present disclosure is demonstrated considering 10 speech signals as the source signal v(n) and a sampling rate fₓ=16 kHz. The feedback path F(z,n) was a measured room impulse response, from [6], with L_{F}=4000 samples. The forward path G(z,n) was defined as (24).

For performance comparison, the PEM-AFROW method was used. The parameters of the PEM-AFROW, except those of the adaptive filter, had the values originally proposed in [1] adjusted to fₛ=16 kHz. For both methods, the adaptive filter's parameters were chosen empirically in order to optimize the MSG(n) in terms of minimum area of instability and, secondarily, of maximum mean value. The evaluation was done in real-world conditions where the source-signal-to-noise ratio (SNR) was 30 dB.

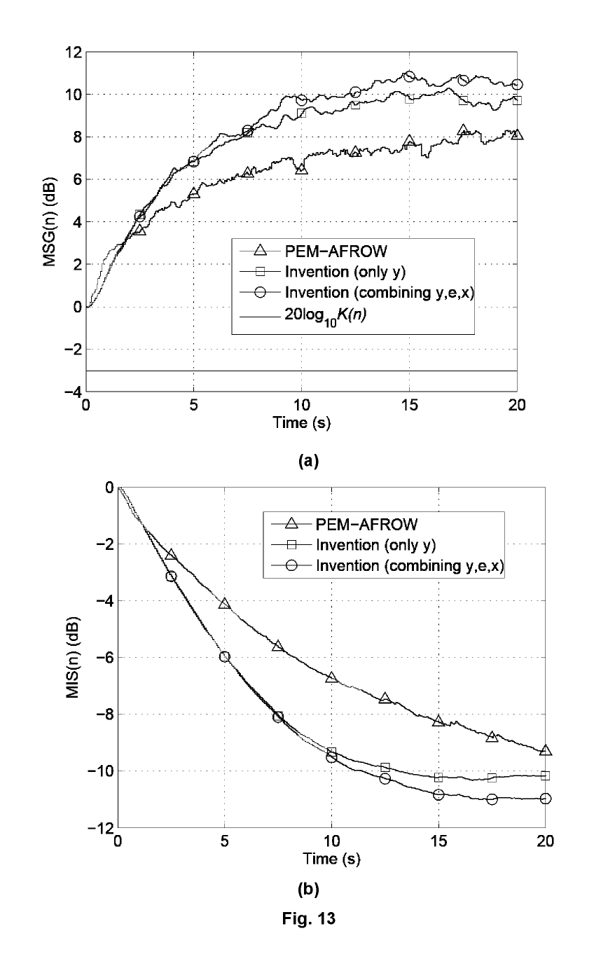

In the first configuration, the broadband gain K(n) remained constant, i.e., ΔK=0. FIG. 13 shows the results obtained by the present disclosure (using only the microphone signal y(n) or combining y(n), e(n) and x(n)) and the PEM-AFROW method for ΔK=0. As can be observed, both configuration of the present disclosure outperformed the state-of-art PEM-AFROW method

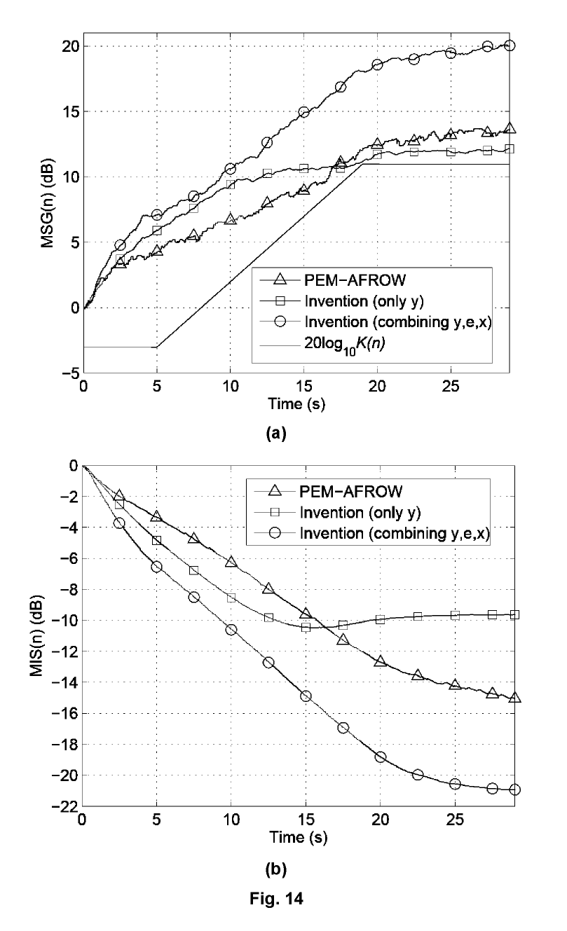

In the second configuration, K(n) was increased in order to determine the maximum stable broadband gain (MSBG) of each method, that is the maximum value of K₂ with which an AFC method achieves a MSG (n) completely stable. Such situation occurred firstly for the present disclosure using only the microphone signal y(n) with ΔK=14 dB. FIG. 14 shows the results obtained by the present disclosure and the PEM-AFROW method for ΔK=14 dB. As can be observed, the present invention using only the microphone signal y(n) performed better than the PEM-AFROW until 10 s. Again, the present disclosure combining y(n), e(n) and x(n) outperformed the PEM-AFROW.

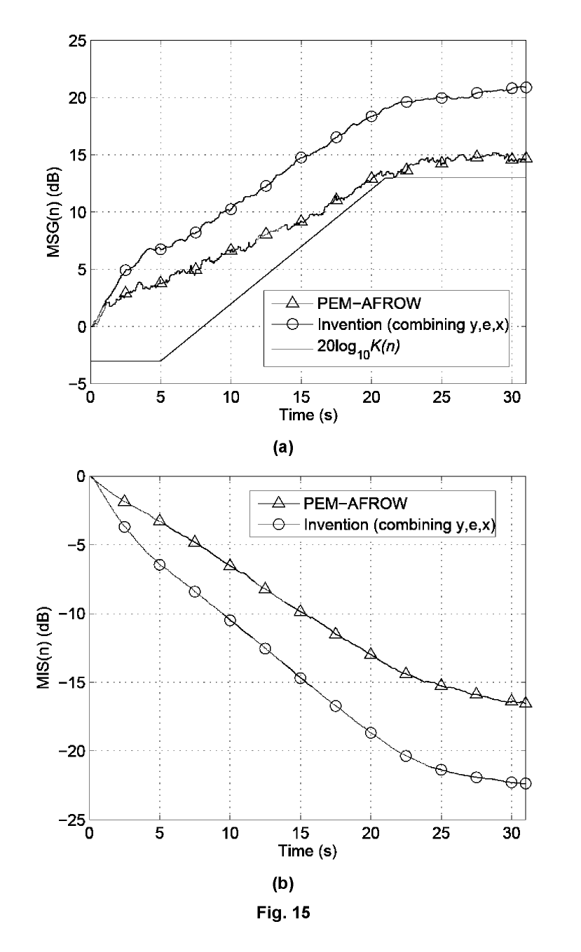

Hereupon, K(n) continued to be increased to determine the MSBG of the other methods. The second method to show a limited stability was the PEM-AFROW with ΔK=16 dB. FIG. 15 shows the results obtained by the present disclosure combining y(n), e(n) and x(n) and the PEM-AFROW method for ΔK=16 dB. Once again, as can be observed, the present disclosure combining y(n), e(n) and x(n) outperformed the PEM-AFROW.

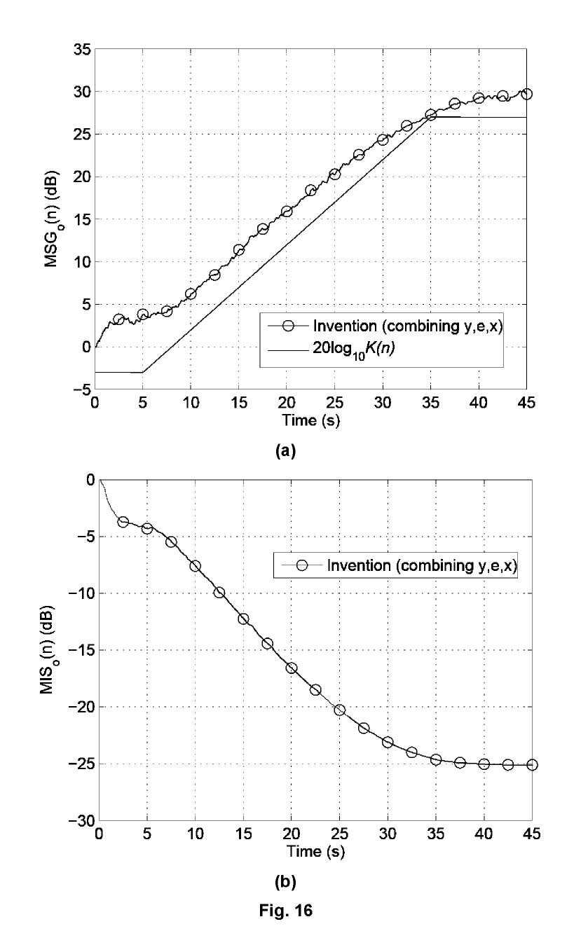

Finally, K(n) was increased further to determine the MSBG of the present disclosure combining y(n), e(n) and x(n). This situation occurred only with an impressive ΔK=30 dB, outscoring by 14 dB the MSBG of the PEM-AFROW method. FIG. 16 shows the results obtained by the present disclosure combining y(n), e(n) and x(n) for ΔK=30. The present disclosure increased in 30 dB the MSG of the PA system and estimated the impulse response f(m,n) of the feedback with a MIS of −25 dB.

The term “comprising” whenever used in this document is intended to indicate the presence of stated features, integers, steps, components, but not to preclude the presence or addition of one or more other features, integers, steps, components or groups thereof.

Flow diagrams of particular embodiments of the presently disclosed methods are depicted in figures. The flow diagrams do not depict any particular means, rather the flow diagrams illustrate the functional information one of ordinary skill in the art requires to perform said methods required in accordance with the present disclosure.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the disclosure as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure is of course not in any way restricted to the embodiments described and a person with ordinary skill in the art will foresee many possibilities to modifications thereof.

The above described embodiments are obviously combinable.

The following claims further set out particular embodiments of the disclosure.

### REFERENCES

1. G. Rombouts, T. van Waterschoot, K. Struyve, and M. Moonen, “Acoustic feedback cancellation for long acoustic paths using a nonstationary source model,” IEEE Transactions on Signal Processing, vol. 54, no. 9, pp. 3426-3434, September 2006.
2. Spriet, I. Proudler, M. Moonen, and J. Wouters, “Adaptive feedback cancellation in hearing aids with linear prediction of the desired signal,” IEEE Transactions on Signal Processing, vol. 53, no. 10, pp. 3749-3763, October 2005.
3. T. van Waterschoot and M. Moonen, “Fifty years of acoustic feedback control: state of the art and future challenges,” Proceedings of the IEEE, vol. 99, no. 2, pp. 288-327, February 2011.
4. M. Guo, S. H. Jensen, J. Jensen, and S. L. Grant, “On the use of a phase modulation method for decorrelation in acoustic feedback cancellation,” in Proceedings of the 20th European Signal Processing Conference, Bucharest, Romania, August 2012, pp. 2000-2004.
5. J. Jensen, M. Guo, Control of an adaptive feedback cancellation system based on probe signal injection, Google Patents, U.S. patent application Ser. No. 13/622,880 (Marche 21 2013). URL http://www.google.com/patents/US20130070936
6. M. Jeub, M. Schafer, and P. Vary, “A binaural room impulse response database for the evaluation of dereverberation algorithms,” in Proc. International Conference on Digital Signal Processing, Santorini, Greece, July 2009.
7. J. Benesty, D. R. Morgan, and M. M. Sondhi, “A better understanding an a improved solution to the specific problems of stereophonic acoustic echo cancellation,” IEEE Trans. on Speech and Audio Processing, vol. 6, no. 2, pp. 156-165, March 1998.
8. J. Hellgren, U. Forssell, Bias of feedback cancellation algorithms in hearing aids based on direct closed loop identification, IEEE Transactions on Speech and Audio Processing 9 (7) (2001) 906-913
9. R. Leber, A. Schaub, Circuit and method for the adaptive suppression of an acoustic feedback, Google Patents, U.S. Pat. No. 6,611,600 (Aug. 26 2003). URL https://www.google.com/patents/US6611600
10 .M. Moonen, G. Rombouts, K. Struyve, T. van Waterschoot, P. Verhoeve, Circuit and method for estimating a room impulse response, Google Patents, EP Patent 1,675,374 (Aug. 4 2010). URL https://www.google.com/patents/EP1675374B1?cl=en

1. Method for cancelling acoustic feedback from a radiator device broadcasting to a receiver device in an environment, comprising:
providing a filter H(z,n) for tracking the acoustic feedback path between the radiator device broadcasting and the receiver device, the input of said filter being the signal x(n) applied to the radiator device;
updating the filter H(z,n) for tracking the acoustic feedback path based on time-domain information contained in the cepstrum c_{y}(τ,n) of the receiver device signal y(n), or
updating the filter H(z,n) for tracking the acoustic feedback path based on time-domain information contained in the cepstrum cₓ(τ,n) of the signal x(n) applied to the radiator device, or
updating the filter H(z,n) for tracking the acoustic feedback path based on time-domain information contained in the cepstrum cₑ(τ,n) of the difference between the receiver device signal and the signal x(n) applied to the radiator device filtered by the filter H(z,n);
subtracting the filter H(z,n) output from the receiver device signal y(n).

2. Method according to claim 1 for cancelling acoustic feedback, comprising the steps of:
(a) supplying the signal x(n) to the filter H(z,n) and to the radiator device broadcasting in the environment,
(b) picking up by means of the receiver device a signal y(n) from the environment, comprising the feedback signal, that is the broadcasted signal filtered by the feedback path, and an input signal u(n),
(c) computing the signal e(n) as the difference between the signal y(n) picked up with the receiver device and a version of the signal x(n) filtered by the filter H(z,n),
(d) calculating the cepstrum c_{y}(τ,n) of the signal y(n),
(e) calculating the cepstra cₑ(τ,n) and c_{c}(τ,n) of the signals e(n) and x(n), respectively,
(f) calculating a time-domain signal p_{y}(m,n) from c_{y}(τ,n),
(g) calculating the time-domain signals pₑ(m,n) and pₓ(τ,n) from cₑ(τ,n) and cₓ(τ,n), respectively,
(h) calculating a time-domain signal ₚ(m,n) by combination or selection of p_{y}(m,n), pₑ(m,n) and/or pₓ(τ,n),
(i) updating the coefficients of the filter H(z,n) by p(m,n) from the previous step,
(j) applying the signal e(n) to the forward path G(z,n) to update the signal x(n).

3. Method according to claim 1 for cancelling acoustic feedback, comprising the steps of:
(a) supplying the signal x(n) to the filter H(z,n) and to the radiator device broadcasting in the environment,
(b) picking up by means of the receiver device a signal y(n) from the environment, comprising the feedback signal, that is the broadcasted signal filtered by the feedback path, and an input signal u(n),
(c) computing the signal e(n) as the difference between the signal y(n) picked up with the receiver device and a version of the signal x(n) filtered by the filter H(z,n),
(d) calculating the cepstrum c_{y}(τ,n) of the signal y(n),
(f) calculating a time-domain signal p_{y}(m,n) from c_{y}(τ,n),
(i) updating the coefficients of the filter H(z,n) by p_{y}(m,n) from the previous step,
(j) applying the signal e(n) to the forward path G(z,n) to update the signal x(n).

4. Method according to any of the previous claims, wherein the steps of the method are performed repeatedly.

5. Method according to any of the previous claims, wherein the signals y(n), e(n) and/or x(n) are divided in frames.

6. Method according to claim 5, wherein the steps of claim 1 are performed more than once per frame.

7. Method according to any of the previous claims, wherein p_{y}(m,n) is an estimate of the impulse response f(m,n) of the feedback path.

8. Method according to any of the previous claims, wherein pₑ(m,n) is an estimate of the impulse response f(m,n) of the feedback path.

9. Method according to any of the previous claims, wherein pₓ(m,n) is an estimate of the impulse response f(m,n) of the feedback path.

10. Method according to any of the previous claims, wherein the signal v(n) is a speech signal.

11. Method according to any of the previous claims, wherein the signal v(n) is an audio signal.

12. Non-transitory storage media including program instructions for implementing a circuit for cancelling the acoustic feedback, the program instructions including instructions executable to carry out the method of any of the claims 1-11.

13. Circuit for cancelling the acoustic feedback as in any of the methods of claims 1 to 11, comprising:
(a) a radiation device arrangement, for broadcasting a signal x(n) in an environment,
(b) a receiver device arrangement, for picking up a signal y(n) from said environment, comprising the feedback signal, that is the broadcasted signal filtered by the feedback path, and an input signal u(n),
(c) a filter H(z,n) having an input for applying the signal x(n),
(c) a summation for computing the signal e(n) as the difference between the signal y(n) picked up with the receiver device and a version of the signal x(n) filtered by the filter H(z,n),
(d) an arrangement for calculating the cepstra c_{y}(τ,n), cₑ(τ,n) and cₓ(τ,n) of the signals y(n), e(n) and/or x(n), respectively,
(e) an arrangement for calculating time-domain signals p_{y}(m,n), pₑ(m,n) and/or pₓ(m,n) from c_{y}(τ,n), cₑ(τ,n) and cₓ(τ,n), respectively,
(f) an arrangement for calculating the time-domain signal p(m,n) by the combination of p_{y}(m,n), pₑ(m,n) and pₓ(m,n),
(g) an arrangement for calculating an update of the coefficients of the filter H(z,n) taking into account p(m,n),
(h) an arrangement for copying the filter's updated coefficients into the filter H(z,n).

14. Circuit according to claim 13 for adaptively estimating a room impulse response.

15. Circuit according to claim 14 for adaptively estimating a room impulse response further including a delay block in said forward path.

16. Circuit according to any of the claims 13-15 wherein the radiator device is a loudspeaker.

17. Circuit according to any of the claims 13-16 wherein the receiver device is a microphone.

18. Circuit according to any of the claims 13-17 for adaptively cancelling an acoustic feedback signal.

19. A public address system comprising the circuit for adaptively cancelling the acoustic feedback signal of claim 18.

20. A sound reinformcent system comprising the circuit for adaptively cancelling the acoustic feedback signal of claim 18.

21. A hearing aid comprising the circuit for adaptively cancelling the acoustic feedback signal of claim 18.

22. A hands-free communication system comprising the circuit for adaptively cancelling the acoustic feedback signal of claim 18.

23. A teleconference system comprising the circuit for adaptively cancelling the acoustic feedback signal of claim 18.
